(19) United States
(12) Patent Application Publication
(10) Pub. No.: US 2012/0127480 A1
(43) Pub. Date: May 24, 2012

(54) TOPOGRAPHY DEVICE FOR A SURFACE OF A SUBSTRATE

(75) Inventors: Francis Pilloud, Clarens (CH); Matthieu Richard, Remoray (FR); Benoît Rosset, Divonne-les-Bains (FR)

(73) Assignee: BOBST SA, Lausanne (CH)

(21) Appl. No.: 13/386,182

(22) PCT Filed: Jul. 16, 2010
(86) PCT No.: PCT/EP2010/004331

§ 371 Date: Jan. 20, 2012

(30) Foreign Application Priority Data
Jul. 24, 2009 (EP) 09009607.4

(51) Int. Cl. G01B 11/02; B31B 1/00; G01B 11/24

(52) U.S. Cl. 356/511; 356/601; 356/602; 493/394

(57) ABSTRACT

A device for analyzing the topography of a surface (2) of a substrate (1) travelling on a substantially planar course with axes X, Y and Z defining an orthonormal frame of reference of the space. The surface (2) is substantially parallel to the plane XY. A device (10) for structured lighting of the surface (2) engages with a device (20) for measuring light backscattered by the surface (2) in order to analyze topography of the surface(2) during travel of the substrate (1). The lighting device (10) projecting a light beam (F) with an angle of incidence ‘a’ onto the surface (2), to form a plurality ‘n’ of luminous streaks (S1, S2, . . . Sn) thereon. Each luminous streak (S) forms an angle ‘b’ with the axis X1. The measurement device (20) includes a linear camera located in a plane P secant to the plane XY and the plane XZ, the intersection of the plane P with the plane XY forming angles.

### TECHNICAL DOMAIN

The present invention relates to a topography device for a surface of a substrate used for the manufacture of packaging.

The invention also relates to a method for the implementation of the topography device according to the invention.

The invention relates finally to a folding-gluing machine comprising a topography device according to the invention.

### PRIOR ART

To manufacture, for example, a medicine box, it is known to transform a plate element of low density by passing it through various machines. A cardboard sheet is an example of a plate element of low density.

A first known conversion is the printing of a cardboard sheet. This operation consists in depositing or in projecting drops of ink onto a face of the sheet.

A second known conversion is the cutting of a cardboard sheet. This operation consists in cutting shapes from said sheet. The cut shapes are called cutouts or blanks. Creasing are also carried out in the blanks so as to delimit panels and facilitate their subsequent folding. These operations are generally carried out in a cutting press.

A third known conversion is the embossing of a blank. This operation consists in embossing a blank so as to produce bumps (or protuberances) on a face of said blank, for example, to form Braille characters. An example of embossing is disclosed by the Applicant in patent application EP-A-1932657 whose content is incorporated by reference into the present description.

A fourth known conversion is the gluing of a blank. This operation consists in depositing or in projecting drops of glue onto a face of the blank. An example of gluing is disclosed in patent application EP-A-1070548 whose content is also incorporated by reference into the present description.

Within the framework of bulk production, it is necessary to be able to check these various conversions on-line so as to ensure that the quality standards in force are adhered to. In particular, when dealing with conversions producing reliefs, such as for example Braille characters or drops of glue, solutions exist which make it possible to detect the presence or otherwise of these reliefs as well as their location on blanks traveling at high speed. On the other hand, these solutions are incapable of checking the proper formation of the reliefs.

To check the proper formation of the reliefs, it is also necessary to be able to measure the three-dimensional characteristics of the reliefs. Solutions using matrix array cameras exist but these solutions are not suited to on-line use because they cannot measure the three-dimensional characteristics of the reliefs under fast enough conditions.

### DISCLOSURE OF THE INVENTION

A first aim of the invention is to remedy the aforementioned drawbacks by proposing a device for checking the proper formation of reliefs on the surface of a substrate traveling at high speed, in a reliable manner which is compatible with the requirements of detection, registering and dimensional characterization of reliefs under industrial conditions.

Accordingly, the subject of the invention is a topography device for a surface of a substrate according to Claim 1.

A second aim of the present invention is to propose a method for the implementation of a topography device according to the invention.

Accordingly, the subject of the invention is a method according to Claim 7.

A third aim of the present invention is to propose a folding-gluing machine equipped with a topography device according to the invention.

Accordingly, the subject of the invention is a folding-gluing machine according to Claim 8.

By virtue of the topography device defined in Claim 1, it is possible to determine the topography of a surface of a substrate thereby making it possible to detect, to register and to characterize reliefs on the surface of the substrate.

Furthermore, by virtue of the method defined in Claim 7, it is possible to measure in a reliable and fast manner all the dimensional characteristics of the reliefs present on the surface of the substrate.

Finally, by virtue of the folding-gluing machine defined in Claim 8, it is possible to check the quality of the formation of reliefs on-line, that is to say during the production of boxes, this check is done for each blank, whatever its speed of travel.

Other objects and advantages of the invention will appear more clearly in the course of the description of an embodiment, which description will be given whilst referring to the appended drawings.

### SUMMARY DESCRIPTION OF THE FIGURES OF THE DRAWINGS

FIG. 1 is a perspective view of a topography device in accordance with the invention;

FIGS. 2a and 2c are views of the angles ‘b’, ‘c’, ‘e’ and ‘f’;

FIG. 3 is a sectional view on a magnified scale of a plate-like element comprising a relief;

FIG. 4 is a representation of the image seen by the linear camera of the device;

FIG. 5 is a representation of the electrical signal, corresponding to the image of FIG. 3, delivered by the photosensitive elements of the linear array camera.

### BEST WAY OF CARRYING OUT THE INVENTION

In the drawing of FIG. 1 has been schematically represented the topography device implemented for the measurement of three-dimensional characteristics of reliefs present on the surface 2 of a cardboard substrate 1 traveling along a substantially plane trajectory of axis X. The plane containing the plane portion of the surface 2 of the substrate 1, that is to say the portion devoid of any relief, is called the reference plane. Axes Y and Z define with the X axis an orthonormal reference of the space in which the reference plane is parallel to the XY plane.

The device comprises a light source 10 able to project obliquely, through an exit pupil 11, onto the surface 2 of the substrate 1, a light beam F adapted for forming a structured lighting according to a determined illumination profile. Preferably, the light source 10 comprises a coherent light source, typically a laser. Advantageously, the structured lighting is obtained by laser interferometry by making two spatially and temporally coherent plane waves, issuing from the light source 10, interfere on the surface 2 of the substrate 1. In this case, the angle of incidence ‘a’ at which the substrate is illuminated is the mean angle formed by the two plane waves with the normal to the substrate. Through this disposition, the structured lighting consists of an array of interference fringes, that is to say a periodic modulation of luminous intensity on the surface 2 of the substrate 1. Advantageously still, the interference fringes are rectilinear parallel and equidistant in the reference plane, alternately light and dark.

As an alternative, the structured lighting may be obtained by projecting the image of a mask back-lighted by LEDs or by any other means known to the person skilled in the art.

In the example illustrated, a plurality ‘n’ of parallel and equidistant rectilinear luminous streaks S1, S2 . . . Sn forms the structured illumination profile. The use of a structured lighting obtained by laser interferometry makes it possible to project a light beam F with a large field depth and makes it possible to obtain luminous streaks of constant sharpness and constant spacing throughout the illuminated zone of the substrate, despite the oblique illumination. The shortest distance between two successive streaks formed in the reference plane is called ‘p1’. Preferably, the distance ‘p1’ lies between 0.01 mm and 0.3 mm, in the example illustrated, the distance ‘p1’ is equal to 0.2 mm. Each streak S extends over a width L on the surface 2 of the substrate 1. Preferably, the width L lies between 0.1 mm and 3 mm, in the illustrated example, the width L is equal to 3 mm.

The light beam F is projected along a mean direction 12 oblique with respect to the substrate 2 at an angle of incidence ‘a’. In the reference plane, each luminous streak S is a linear segment forming an angle ‘b’ with the X axis. Advantageously, the angle ‘b’ lies between −45° and +45°, preferably, ‘b’ is equal to 0°. Moreover, it will be noted that the array of luminous streaks S1, S2 . . . Sn formed on the surface 2 of the substrate 1 is substantially delimited by a rectangle of length L1 and of width L where L1 is equal to p1×n. This rectangle defines a lighting zone 3 for an observation zone 23. Preferably, the length L1 lies between 10 mm and 100 mm, in the illustrated example, the length L1 is equal to 42 mm.

It is recalled that the luminous streaks S1, S2 . . . Sn are rendered visible by the well known phenomenon of scatter to the impact of the light beam F issuing from the light source 10, on the surface 2, also called backscatter or diffuse reflection.

The device according to the invention also comprises means for measuring the lighting of the surface 2 by said streaks S, means consisting of a linear camera 20 comprising a linear sensor and a lens (neither of which are represented). The linear sensor is of CCD or CMOS type. Advantageously, the linear camera 20 is a high dynamic range camera so as to be able to measure the lighting of any surface, whatever its reflectivity in the observation zone.

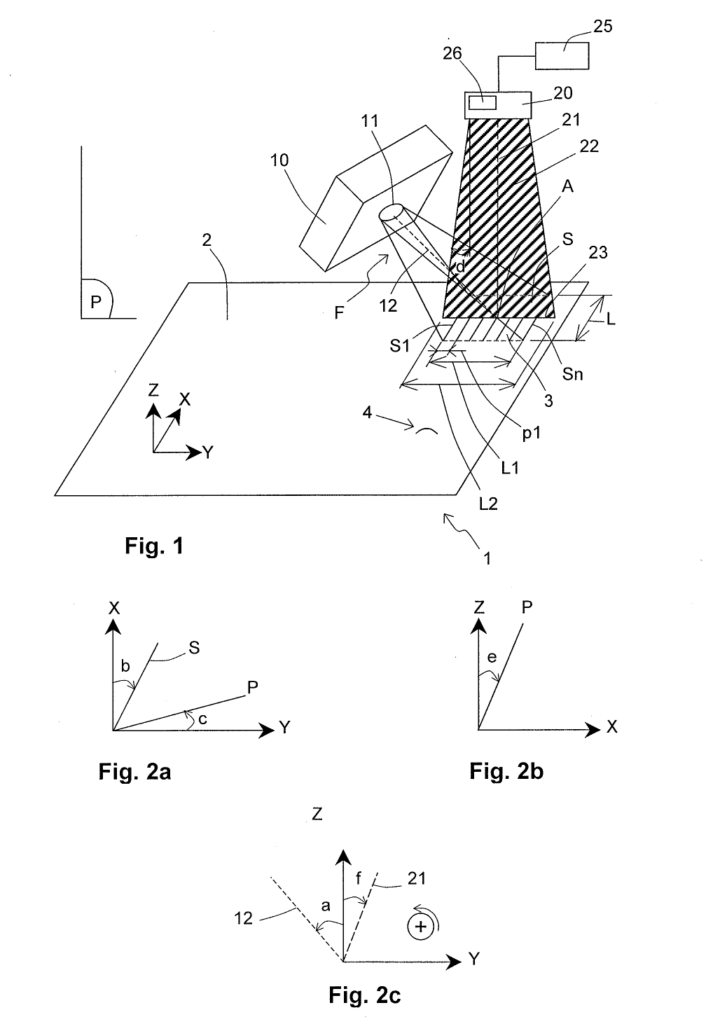

Because the camera 20 is linear, the camera's observation zone 23 is reduced to a narrow observation strip of length L2 and of width L3 (not represented), also called the measurement line. This measurement line is imaged on the linear sensor of the camera 20 by virtue of the latter's lens. The width L3 lies between 0.01 mm and 0.1 mm. The mean direction of observation of the camera 20 is represented by a dashed line 21 forming an angle ‘f’ with the Z axis (see FIG. 2c), the line 21 belongs to the XZ plane and passes through a point A situated in the middle of the measurement line. In a preferred embodiment, the angle ‘f’ is zero. Through this disposition, the measurement line imaged by the camera 20 is sharp over the whole of the length L2 and the magnification is constant over the whole of this length.

In the particular case where the surface 2 is essentially reflecting, for example when the substrate is coated with a layer of aluminum, it is advantageous to use an angle ‘f’ equal to the angle ‘-a’, doing so in order to collect the specularly reflected light. In this case, the person skilled in the art will use known techniques to get a sharp image over the whole of the measurement line.

The type of lens of the camera 20 and the distance from the camera 20 to the surface 2, called the observation distance, are chosen so that the maximum field angle denoted ‘d’ is small, in view of the length L2 of the observation strip, doing so in order that the direction of observation may be almost perpendicular to the axis Y, over the whole of the length L2. Advantageously, a lens of telecentric type will be used to observe the measurement line in a direction of observation perpendicular to the Y axis, over the whole of the length L2, while retaining a minimum distance between the camera 20 and the surface 2, in this case, the angle ‘d’ is almost zero. For a lighting distance of 130 mm, the observation distance is for example equal to 100 mm.

In the case where the lens is not telecentric, the direction of observation is not perpendicular to the Y axis over the whole of the length L2. In this case, to make accurate measurements, the person skilled in the art will take into account the variation of the angle ‘d’ along L2 and will apply an appropriate correction process by using, for example, a calibration on the reference plane.

The camera 20 with its linear array of photosensitive elements is situated in a plane P secant to the XY plane and to the XZ plane. The intersection of the plane P with the XY plane forms an angle ‘c’ with the Y axis (see FIG. 2a). Likewise, the intersection of the plane P with the XZ plane forms an angle ‘e’ with the Z axis (see FIG. 2b). Advantageously, the angle ‘c’ lies between −30° and +30°, preferably ‘c’ is equal to 0°. Advantageously still, the angle ‘e’ lies between −45° and +45°, preferably ‘e’ is equal to 0°. Thus, in a particular embodiment where the angle ‘b’ is equal to 0°, where the angle ‘c’ is equal to 0° and where the angle ‘e’ is equal to 0°, the rectilinear luminous streaks S1, S2 . . . Sn are orthogonal to the plane P. In a preferred embodiment, the light source 10 and the linear camera 20 are arranged in such a way that the length L1 is at least equal to the length L2.

The light source 10 emits preferably in a wavelength situated between 400 nm and 1100 nm, the power of such a light source is of the order of 1 to 100 mW.

The camera 20 is for example a linear camera with a single line of 2048 pixels. The unidimensional image acquired by the camera 20 is stored in a memory 26. The data of the memory 26 are used by a triangulation algorithm described further on. Thus, for a speed of acquisition of forty thousand lines per second and for a speed of travel of the substrate of 8 meters per second, a resolution along the axis X of 0.2 mm is obtained, corresponding to the distance of displacement of the substrate between two successive measurement lines, this being sufficient to deduce in a reliable manner the topography of a surface of a substrate passing through the observation zone, such as for example the topography of a surface exhibiting Braille characters or glue spots or any other relief on the surface of a substrate, notably a substrate used for the manufacture of packaging.

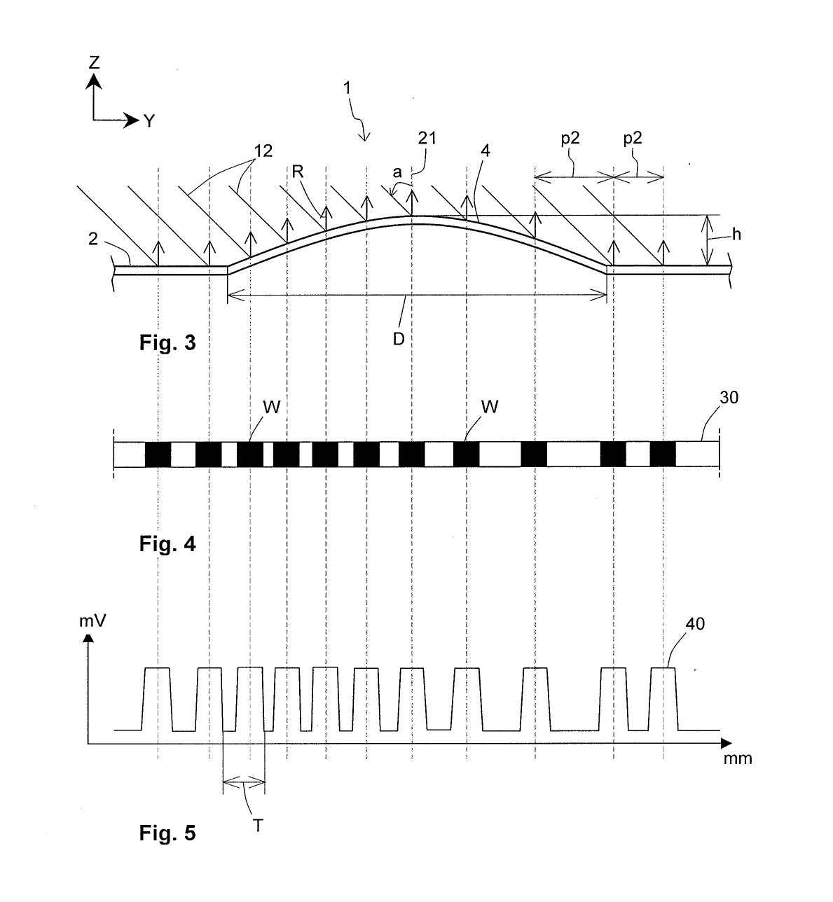

The angle of incidence ‘a’ advantageously lies between 30° to 70°, preferably between 45° and 60°. As will be better understood in view of FIG. 3, this angle is chosen as a function of the dimensional characteristics of the reliefs that it is desired to perform the topography.

In FIG. 3 has been represented a sectional cut in the plane P, on a large scale, through a relief on the surface 2 of a blank 1. In this example, the relief is a bump 4 characterized by a height ‘h’ of about 0.2 mm and a diameter ‘D’ of about 1.6 mm at its base (typically a Braille point). With an angle of incidence ‘a’ equal to 45° and a resolution of 0.2 mm, when the blank 1 crosses the plane P at a speed of 8 m/s, seven or eight topography records of the bump 4 may be performed in succession, this being sufficient to deduce therefrom the three-dimensional characteristics of said bump.

FIG. 3 shows the bump 4 at the moment at which its top crosses the plane P. The streaks S1, S2 . . . Sn which are projected onto the surface 2 along the mean direction 12 are backscattered in several directions and in particular toward the linear camera 20. In the particular case where the lens of the linear camera 20 is of the telecentric type and that the angle ‘e’ is zero, the backscattered rays observed by the camera 20 are orthogonal to the surface 2 of the blank. The orthogonal light rays backscattered by the ‘n’ streaks S1, S2 . . . Sn in the plane P subsequent to the impact of the light beam F on the surface 2 are called R1, R2 . . . Rₙ respectively. Likewise, the shortest distance between two successive orthogonal light rays backscattered in the plane P is called ‘p2’. Each orthogonal light ray is represented by an arrow R.

The mean direction of observation 21 of the linear camera 20 being perpendicular to the surface 2, the camera 20 sees the orthogonal light rays R1, R2 . . . Rₙ backscattered in the plane P. Because of the bump 4, these orthogonal light rays are not equidistant over the whole of the length L1, stated otherwise, the distance ‘p2’ is variable. Indeed, as long as no relief is situated in the observation zone, the camera 20 is excited by light backscattered in concordance with the structured illumination profile. On the other hand, as soon as a relief is situated inside the observation zone, it causes a spatial shift of the luminous streaks S1, S2 . . . Sn and, therefore, of the excitation of the corresponding photosensitive elements of the camera 20. This is due to the fact that the topography device according to the invention operates on the well known principle of triangulation, according to which principle the angle of incidence ‘a’ is nonzero, so that a variation in the distance between the camera 20 and the surface 2 results in a lateral shift of the light rays received by the camera 20. It is the measurement of this shift which makes it possible to determine the three-dimensional characteristics of the surface 2 and therefore to verify the proper formation of the bump 4. Thus, a processor 25 applies a triangulation algorithm to each image acquired by the camera 20. A known example of a triangulation algorithm is given by the following formula: “lateral shift”=tan(‘a’)×“vertical shift”; where tan('a′) is the tangent of the angle of incidence ‘a’, where “vertical shift” is the shift on the Z axis of the light rays received by the camera 20 and where “lateral shift” is the shift on the Y axis of the light rays received by the camera 20. In the example illustrated, the triangulation algorithm is applied line by line, independently of one another. In a variant embodiment, the triangulation algorithm uses the stored data of several adjacent lines.

In practice, if the angle of incidence ‘a’ exceeds 70°, the detection of reliefs becomes very sensitive but the topographical record becomes less reliable because of the fact that shadows of the reliefs may appear. If, on the other hand, the angle of incidence ‘a’ falls below 30°, the sensitivity rapidly decreases because of the fact that the shifting of the luminous streaks S1, S2 . . . Sn becomes less visible.

In FIG. 4 has been represented an image 30 of the luminous streaks S1, S2 . . . Sn, seen by the camera 20 when the bump 4 is in the position of FIG. 3. The camera 20 being linear, the latter sees only a single luminous point of each streak. The dark zones W represent the photosensitive elements of the camera 20 which receive light. The corresponding electrical signal 40 is represented in FIG. 5.

In FIG. 5 has been represented the periodic electrical signal delivered by the array of photosensitive elements. The presence of reliefs on the surface of the blank in the observation zone causes a spatial shift as explained previously. This shift is spotted by a decrease or an increase in the period T of the signal 40. In the example illustrated, when the period T decreases, this signifies that the light source 10 is illuminating a region of positive difference in level of the surface 2, conversely, when the period T increases, this signifies that the light source 10 is illuminating a region of negative difference in level of the surface 2.

It will be noted that in the absence of relief on the surface of the blank in the observation zone, the period T is substantially constant over the whole of the length of the array of photosensitive elements.

The device according to the invention may be implemented in the following manner: a light beam F is projected obliquely onto the surface 2 so as to form thereat ‘n’ luminous streaks S1, S2 . . . Sn, thereafter the spatial shift of the luminous streaks S1, S2 . . . Sn is measured for each acquired image, and finally a triangulation algorithm is applied to each measured shift.

The device according to the invention can advantageously be mounted in a folding-gluing machine comprising a conveyer for conveying plate-like elements 1 along a substantially plane trajectory of axis X.

Although the topography surface is that of a plate-like element, it goes without saying that the invention also applies to a substrate taking the form of a web of material.

1. A topography device for a surface of a substrate that is traveling along a substantially plane trajectory along an axis X, wherein the axis X defines with axes Y and Z an orthonormal reference of a space in which the surface is substantially parallel to the XY plane, the topography device comprising
a structured lighting device for lighting of the surface and a cooperating device for measuring lighting backscattered by the surface and the topography of the surface during traveling of the substrate along axis X;
the structured lighting device is configured and operable to project a light beam onto the surface, at an angle of incidence ‘a’, so as to form at the surface a plurality ‘n’ of luminous streaks wherein each luminous streak forms an angle ‘b’ with the X axis;
the measurement device comprising a linear camera situated in a plane P secant to the XY plane and to the XZ plane, the intersection of the plane P with the XY plane forming an angle ‘c’ with the Y axis, the intersection of the plane P with the XZ plane forming an angle ‘e’ with the Z axis, wherein the angle of incidence ‘a’ lies between 30° and 70°, the angle ‘b’ lies between −45° and +45°, the angle ‘c’ lies between −30° and +30° and the angle ‘e’ lies between 45° and +45°.

2. The topography device according to claim 1, wherein the angle of incidence ‘a’ lies between 45° and 60°.

3. The topography device according to claim 1, wherein the angle ‘b’ is equal to 0°.

4. The topography device according to claim 1, wherein the angle ‘c’ is equal to 0°.

5. The topography device according to claim 1, wherein the angle ‘e’ is equal to 0°.

6. The topography device according to claim 1, wherein the structured lighting device comprises a laser interferometer and an array of interference fringes constitutes the structured lighting.

7. A topography method for a surface of a moving substrate that is traveling along a substantially plane trajectory along an axis X wherein the axis X defines with axes Y and Z an orthonormal reference of the space in which the surface is substantially parallel to the XY plane, the method comprising the following steps:
projecting a light beam obliquely onto the surface so as to form a plurality ‘n’ of luminous streaks,
taking successive images of the surface with a linear camera situated in a plane P secant to the XY plane and to the XZ plane,
measuring the spatial shift of the luminous streaks for each acquired image,
applying a triangulation algorithm to each measured shift and determining the topography.

8. Folding-gluing machine comprising:
a conveyer for conveying plate-like elements along a substantially plane trajectory of axis X, and a topography device defined according to claim 1, for determining the topography for a surface of the plate-like elements, and for checking a quality of a formation of reliefs on-line on the surface of the plate-like elements in the folding-gluing machine, wherein the traveling substrate is defined as the plate-like elements.

9. (canceled)

10. Topography device for a surface of a plate element that is traveling in a folder-gluer along a substantially plane trajectory of axis X wherein the axis X defines with axes Y and Z an orthonormal reference of the space in which the surface is substantially parallel to the XY plane, the topography device comprising
a structured lighting device for lighting the surface and a cooperating device for measuring lighting backscattered by the surface and the topography of the surface during traveling of the plate element in the folder-gluer;
the structured lighting device is configured and operable to project a light beam onto the surface at an angle of incidence ‘a’, so as to form at the surface a plurality ‘n’ of luminous streaks, wherein each luminous streak forms an angle ‘b’ with the X axis;
the measurement device comprises a linear camera situated in a plane P secant to the XY plane and to the XZ plane, the intersection of the plane P with the plane XY forming an angle ‘c’ with the Y axis, the intersection of the plane P with the plane XZ forming an angle ‘e’ with the Z axis, wherein the angle of incidence ‘a’ lies between 30° and 70°, the angle ‘b’ lies between −45° and +45°, the angle ‘c’ lies between −30° and +30° and the angle ‘e’ lies between 45° and +45°.
